(19) United States
(12) Patent Application Publication
(10) Pub. No.: US 2014/0084794 A1
(43) Pub. Date: Mar. 27, 2014

(54) Method for programming a LED light using a light sensor

(71) Applicants: Richard Jeff Garcia, Beaumont, CA (US); Michael Patrick Babb, Corona, CA (US)

(72) Inventors: Richard Jeff Garcia, Beaumont, CA (US); Michael Patrick Babb, Corona, CA (US)

(21) Appl. No.: 13/573,543

(22) Filed: Sep. 22, 2012

(51) Int. Cl. H05B 37/02

(52) U.S. Cl. 315/149

(57) ABSTRACT

A method for programming a LED light that uses a light control circuit that includes a light sensor to read the data from an encoded light source, where the encoded light source would typically by a LCD display. This allows the LED light to have a wide array of options where the user only selects the options or modes that they want the light to have.

### CROSS REFERENCE TO RELATED APPLICATIONS

This application claims the benefit of provisional patent application No. 61/626,266 filed Sep. 24, 2011 by the present inventor.

### FEDERALLY SPONSORED RESEARCH

Not Applicable

### SEQUENCE LISTING OR PROGRAM

Not Applicable

### BACKGROUND

### Prior Art

The following tabulation is some prior art that presently appears relevant:

| Pat. No. | US Patent Issue Date | Patentee |
|---|---|---|
| 5,570,297 | Oct. 29, 1996 | Brzezinski et al. |
| 13/364,703 | Not issued | Sharrah et al. |
| 20080272714 | Not issued | Noble; Barry Angus, et al. |
| 8,203,581 | Jun. 19, 2012 | Garcia, et al. |

This application relates to using light to program an LED light. As LED lights fill more and more applications sometimes additional functionality is required. This additional functionality then, in turn, sometimes requires various settings. Consider LED flashlights. There are currently several types of LED flashlights that allow users to program the various modes expressed by the LED flashlight. This is required because the LED flashlights can have so many different modes that if they are all enabled clicking the light on and off to wade through the modes is inconvenient. Examples of flashlight modes include a multitude of settings between the brightest setting and the lowest setting, various strobe settings with different blink rates, SOS type of flashing, and sometimes patterns. There are currently some LED flashlights that are programmable via USB computer interfaces. Other LED flashlights are programmed via a series of timed button presses. There are problems with these types of interfaces. For example, programming a LED flashlight via a series of button presses presents the user with a complicated and convoluted series of button presses to work through in order to setup or customize their light. Additionally sometimes precise time intervals are required for the button clicks, further complicating the process. The USB computer interface presents its own problem of having to have a special cable for the purpose of programming. The USB programming header presents a potential trouble spot for leaks or being fouled with dirt or debris. Some smaller products don't have much space available for plugs making for additional challenges. In addition to the LED flashlight example, other LED lights use dip switches that can be arranged in a pattern to adjust the settings.

There is one other device that was programmed without a cable however it was a wrist watch that worked with older computer monitors. This approach required a cathode ray tube based device, since it derived it's timing from the commonly used CRT screen scan rates. These devices have gone away as CRT have become obsolete.

### ADVANTAGES OVER PRIOR ART

The prior art allows for flashlight settings to be changed or programmed however, they suffer from some drawbacks that my method overcomes. My method does not require a cable, which saves both the cost of the cable as well as not requiring the limitations that a connector imposes, such as protecting the connector from debris and water or making space for the connector on a round surface. Furthermore, my software can be hosted on the interne and then run on any mobile phone, computer, tablet, or any other browser enabled device. If a cable was required it would tether the user to only a couple of these devices since no able exists that is universally supported. My method overcomes the problem of complicated button pressing sequences since the software will be encoding the selected settings.

This new invention enjoys substantial advantages over the CRT based prior art. The older CRT methods known to the art wouldn't work with more modern LCD based devices, which is a large drawback as CRT based monitors have largely vanished. Another difference between these older CRT methods and the invention disclosed in this application is that this new invention works with a wide range of screen refresh rates and resolutions. The older CRT based methods were much more limited and would not have worked with a wide array of devices since they required known refresh rates. Indeed, they required calibration by having the wrist watch beep when the timing was just right and required the user to keep those settings. Finally, the CRT based devices were wrist watches and not lights so they didn't have the additional challenges of making sure that the light from the LED light did not interfere with the light sensor measurements.

### SUMMARY

This invention allows any LED light with a light sensor to be programmed without requiring a cable from any liquid crystal display (LCD) based device.

### DRAWINGS

Figures

FIG. 1—This is a top view of one embodiment, it shows the LEDs and light sensor

FIG. 2—This is a flow chart that shows the programming process over view

FIG. 3—This flow chart shows how the light sensor is used to decode the bits

### REFERENCE NUMERALS

10—LED
20—Light Sensor

### DETAILED DESCRIPTION

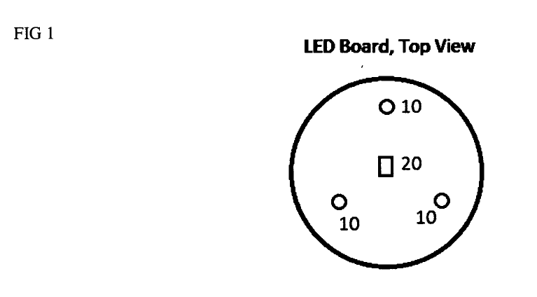

### FIG. 1

FIG. 1 shows one embodiment, in this case a flashlight that has 3 LEDs and a single light sensor in the middle. The light sensor could be shielded from the LEDs to prevent light from the LEDs from interfering with the light sensor's readings. Or the embodiment could use the method described in U.S. Pat. No. 8,203,581 where the light sensor is measured during the off cycle of the dimming.

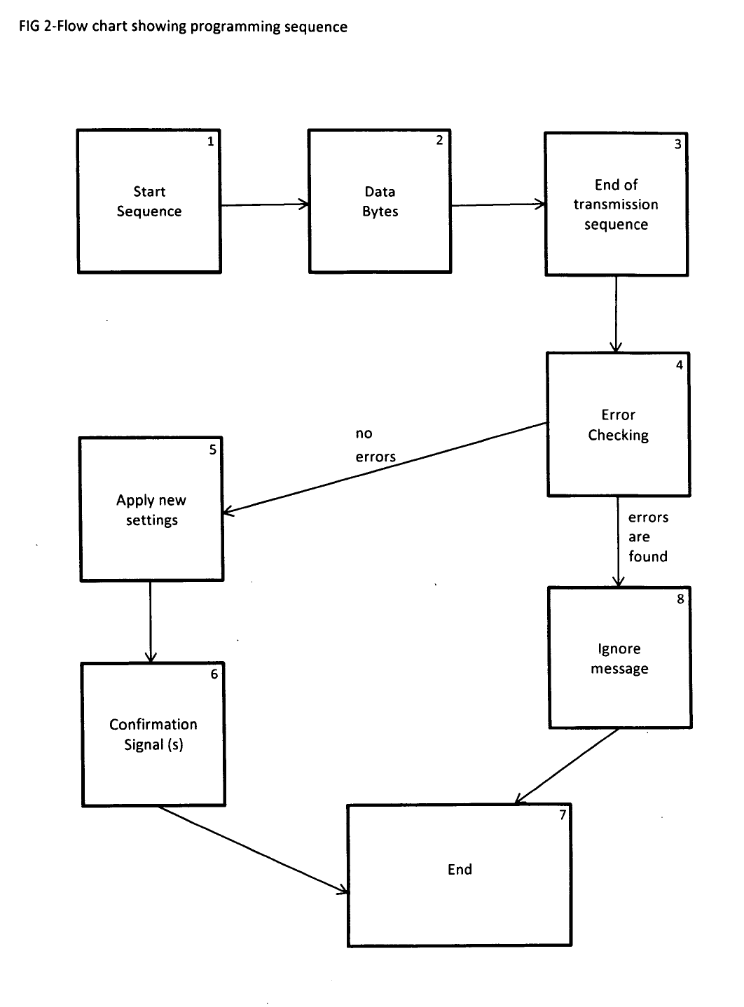

### FIG. 2

FIG. 2 shows a flow chart that describes the overall process from a high level.

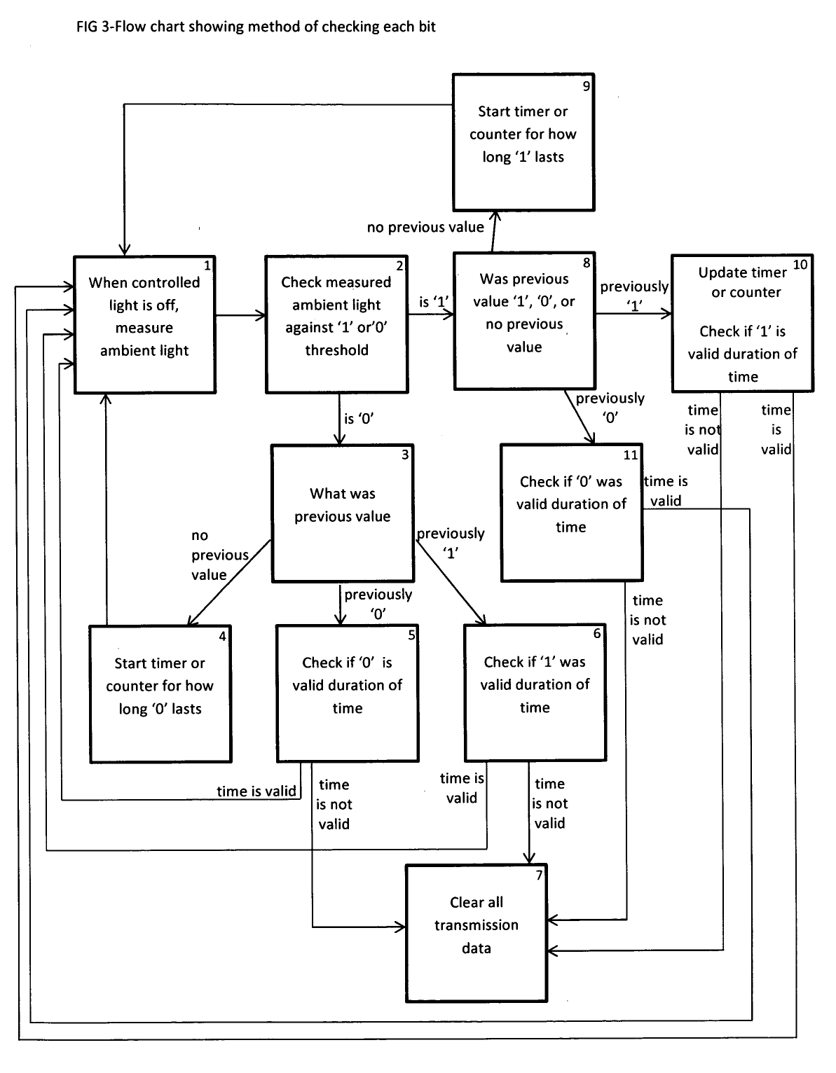

### FIG. 3

FIG. 3 shows how individual light measurements are used to determine the bit values, literally the 1's and 0's that make up the communication.

### Operation

### FIGS. 1, 2, and 3

The operation will be described for the first embodiment, an LED flashlight with the LEDs and light sensor arranged as shown in FIG. 1. The flashlight takes a light measurement every 10 ms during the off portion of the PWM duty cycle. This method is fully disclosed in U.S. Pat. No. 8,203,581. As shown in FIG. 3, the measured value of the light sensor is used to determine if the flashlight may be seeing a 1 or a 0. For this embodiment thresholds determined when the light was designed were used though there are some alternate methods that will be described later that could have been implemented instead. Depending on the value measured from the light sensor one of 3 cases will be true: either the measured value will be 0, 1, or out of range and thus neither a 0 nor a 1. If the value is out of range then the flashlight clears any data that might have been transmitted up to that point. A single bit error will cause the whole transmission to be ignored and cleared out. If the measured light value was either a 0 or 1 then a state machine will compare that against previous values. If the state machine detects an error, for example if the 0 or 1 state is too long or too short, then again it will clear out any data and ignore the transmission. Note that until the bit status changes, for example goes from 0 to 1, the time duration of that bit is unknown. What is known is that if a bit time duration persists too long without changing then it violates the timing structure by being too long of a time duration and the message is cleared out and the state machine starts over. The bits are also tested for a valid time duration when the bit value changes; in case the time duration was too short.

Assuming that the bit timing are correct the general sequence of events is shown in FIG. 2, starting off with a start of message sequence, then the data, then the end of message sequence. The bit timing for the start message and end of message commands is different from the bit timing for the data. This keeps a flashing light that just happens to be at the same frequency as the flashlight is expecting from accidentally changing the lights settings. A flashing light may have the same time sequence as the start/end of message or as the data part of the message but it couldn't have both since they were intentionally picked to be very different and there is no way to meet the timing specs using a single frequency. Also, the overall data rate is very slow and was made so intentionally. The reason why is because ideally the flashlight would be able to be programmed from any internet enabled device, and these devices vary greatly with regards to LCD screen refresh rate. By picking the slowest common denominator all devices can be used to program the flashlight by blinking at the light sensor.

If the entire transmission proceeds without error, then the flashlight will blink several times as an acknowledge signal for the user. This lets the user know that the message was successfully received. Since the software advises the user when the message is complete and tells the user to look for the confirmation blinking the likelihood of making a mistake is greatly reduced. This also helps with troubleshooting the process. For example, if the person has the brightness on their LCD screen set very low there may not be enough light to register well on the light sensor, thus causing the process to fail. Since the user could see that the confirmation blinks didn't happen they would know that something went wrong and could ask for help.

### Operation

### Alternate Embodiments

There are several alternate embodiments for this method. One would be to not co-locate the light sensor with the LEDs as shown in FIG. 1. The advantage of this method is that by locating the light sensor away from the LEDs a wider variety of optical lenses and reflectors can be used. Although the light sensor could be placed anywhere one spot that should be specifically mentioned is putting the light sensor in the tail cap of a flashlight. The reason why this is particularly novel and useful is that then the driver is abstracted away from the LEDs allowing for lower cost LED modules to be installed. This is particularly useful because as LED technology is rapidly improving lower cost modules that only have LEDs and can be easily replaced are enabled. Also, by putting the light sensor and driver in the tailcap any LED lens or reflector can be used, which is helpful for deep reflectors that produce very narrow angle light patterns.

Alternate embodiments could also change the light transmission scheme. Instead of using only black and white patterns, as is done now, colors and a light sensor that can distinguish colors could be alternately used. This would allow for potentially higher data rates as multiple bits of information could be sent with a single color. The wider the range of colors that the light sensor could detect, the more bits of information that each single transmission would transfer. This might also allow for improved transmission range since the light color, and not the light intensity, is being used to encode the data.

Alternate embodiments could also change the values of light as noted in the description above. For example, the present embodiment uses hard coded threshold values for what measured value is 0, 1, or out of range. An alternate embodiment would be to look for patterns of relative change instead of absolute values. This would allow for the light sensor to not have to be as close to the LCD screen. This would also help in situations where the LCD brightness is not as bright as expected. For example in the current embodiment if the user has the brightness setting on their LCD monitor too low then it won't work. If instead the software was looking for relative changes in the light sensor's measured values then it would work even at very low LCD brightness settings.

### Advantages

From the detailed description above a number of advantages over the prior art become evident.
(a) By using light instead of a plug, such as a USB connector, the housing is able to avoid the drawbacks to a plug such as water intrusion or fouling of the plug due to dirt or debris. Not requiring a cable also lowers the cost and saves the user the hassle of having to always have a cable with them. Additionally, there is no style of plug that is universally accepted across all computers, phones, and tablets thus forcing multiple styles of cables or adapters to be used. This lack of common plug style creates more cost and inconvenience.
(b) By using a lower modulation rate this invention is designed to work with LCD displays rather than CRT displays. This is a large advantage because although CRT displays are quickly being phased out, LCD displays are becoming more common. The lower modulation rate also works with all devices since the low data rate means that even when the screen refresh rate is low it will still work. By going with the low data rate the calibration described in the prior art for CRT based devices is avoided.
(c) By allowing the device to be more easily programmed parameters can have a much wider range of values. For example, if you wanted to have a custom light intensity from 1% to 100% the only practical way to select the desired percentage would be with a software interface. It is utterly impractical to try and have button click combinations express details such as this.
(d) By allowing the device to be personalized all customers can have a light that they are happy with. There is no one set of modes that will please all customers. While that sounds like common sense, the typical approach has been to select a combination of modes that will please the greatest number of people. Allowing the LED light to be easily customized pleases all the people. Best of all, should the needs change a new set of parameters can be easily downloaded so the LED light will always have the desired features.
   Although the descriptions above contain many specificities, these should not be construed as limiting the scope of the embodiments but as merely providing illustrations of some of several embodiments. For example, I used a LED flashlight as an example but the same benefits and advantages of this method would apply to other LED lights such as LED headlamps, LED bike lights, etc. Thus the scope of the embodiments should be determined by the appended claims and their legal equivalents rather than by the examples given.

We claim:

1. A lighting system having: a light source, a power source for providing electric current to the light source, a control unit for controlling operation of said light source, a light sensor, memory, and software within said control unit that can accept commands or data using said light sensor and store any data or changes said commands produce to said memory.

2. The control unit according to claim 1 where said data or said commands are encoded in different combinations of light color.

3. The control unit according to claim 1 where said data or said commands are encoded in different combinations of light intensity.

4. The control unit according to claim 1 where said commands or said data are encoded in different lengths of time.

5. The control unit according to claim 1 where said memory is non-volatile memory.

6. A method for sending data to a light controller circuit, where said light controller circuit includes a light sensor and memory, using encoded changes in light to transmit said data where said light can be detected by said light sensor where said encoded changes in light are determined to be data by said light controller circuit and said data can be stored in said memory of said light controller circuit.

7. The method of claim 6 where said encoded changes in light include changes in light color.

8. The method of claim 6 where said encoded changes in light include changes in frequency or duration.

9. The method of claim 6 where said encoded changes in light include changes in light intensity.

10. The method of claim 6 where said memory is non-volatile memory.

11. The method of claim 6 where the time encoding uses more than one frequency rate for said data.

12. A lighting control circuit that includes a light sensor and memory where said lighting control circuit is configured to measure said light sensor to determine if data is detected by said light sensor and if said data is detected to store said data in said memory.

13. The lighting control circuit of claim 12 where said memory is non-volatile memory.

14. The lighting control circuit of claim 12 where said data is encoded in different colors.

15. The lighting control circuit of claim 12 where said data is encoded in different increments of time for different values.

16. The lighting control circuit of claim 12 where said data is encoded in both one or more increments of time as well as one or more colors.

17. The lighting control circuit of claim 12 where said data is encoded in light by changes in light color.

18. The lighting control circuit of claim 12 where said data is encoded in light by changes in frequency.

19. The lighting control circuit of claim 12 where said data is encoded in light by changes in light intensity.

20. The control unit according to claim 1 where said light source gives a confirmation signal upon successful reception of said commands or said data.

21. The method of claim 6 where said light controller circuit causes the light it controls to give a confirmation signal upon successful reception of said data.

22. The lighting control circuit of claim 12 where said lighting control circuit causes the light being controlled to give a confirmation signal upon successful reception of said data.
